(19) United States
(12) Patent Application Publication
(10) Pub. No.: US 2010/0117442 A1
(43) Pub. Date: May 13, 2010

(54) WHEEL BALANCE CLIP

(76) Inventor: John Halle, Powys (GB)

Correspondence Address: CARSTENS & CAHOON, LLP, P O BOX 802334, DALLAS, TX, 75380, US

(21) Appl. No.: 12/529,232

(22) PCT Filed: Mar. 3, 2008
(86) PCT No.: PCT/GB08/00736

§ 371 Date: Aug. 31, 2009

(30) Foreign Application Priority Data
Mar. 2, 2007 (GB) 0704085.0

(51) Int. Cl. B60B 30/00

(52) U.S. Cl. 301/5.21

(57) ABSTRACT

The invention relates to a wheel balance clip (200) comprising: a spring portion (210) arranged to accommodate and attach to the rim of a wheel; and an attachment portion (220) depending from the spring portion (210), the attachment portion (220) having a face (250) wherein the face (250) is provided with at least one protrusion (260), arranged such that, when in use, the at least one protrusion (260) interacts with the rim of a wheel on which it is fitted so as to aid the retention of the clip (200) such that the protrusion causes the face of the clip to move away from the rim.

### FIELD OF THE INVENTION

The present invention relates to a wheel balance clip and related methods.

### BACKGROUND OF THE INVENTION

Where a tyre fitted to a wheel (or indeed the wheel itself) is heavier at one side than the other an out-of-balance vibration can manifest during driving, which can cause noticeable vibration on the steering wheel, and through the car itself. This causes tyres and mechanical parts to wear more quickly and ultimately could render a vehicle unsafe. Wheel balance weights are used to correct out-of-balance defects on tyred wheels, and are arranged to attach to the rims of wheels used by vehicles such as cars, buses, trucks or the like.

Where a tyre or wheel rim is observed to be out-of-balance, a wheel balance weight of compensatory measure may be attached to the rim of the wheel diametrically opposite the heavier portion of the tire/wheel.

For some types of wheels, previous wheel balance weights have either been provided as complete assemblies, whereby a weight portion is cast around a clip to provide a consolidated assembly, or as a separate clip and weight portions, which arranged to be mechanically attached to one-another.

Such wheel balance weights are attached by means of an integral U-shaped spring that is arranged to open and close elastically upon the rim of the wheel to retain the clip in position. During their lifetime however as a vehicle accelerates and decelerates the wheel balance weights will experience forces acting either to encourage removal of the weights from the rim, and/or to encourage them to displace circumferentially around the rim. In each case this can lead to the failure of the countermeasure.

Another problem is that many current wheel balance clip designs are suitable only for wheels of an alloy construction. Because of the moulding process used to produce these wheels the wheel rims are limited to having a profile such that their distal ends are angled upwards or at least not downwards relative to an axis of the wheel. Steel wheels however can be manufactured such that the distal end of the wheel rim has a lip (angled to have a downward pointing profile). Indeed, the distal end of a steel rim is commonly rolled over in order to prevent sharp edges from contacting a tyre. Moreover, steel rims are fabricated from thinner material when compared to so-called alloy rims.

Also, as technology improves, the steel from which steel wheel rims are fabricated has gotten thinner. However, vehicles with older wheels still need new tyres and as such need their wheels to be balanced. Wheel balancing centres therefore have to fit balance weights to wheels being fabricated from materials of a variety of thicknesses.

This presents a problem in that, to be effective, a clip should be able to accommodate a variety of different gauge materials. If the opening in a clip is too narrow, then that clip can be damaged when it is attempted to fit it to a thicker rim. If the opening in a clip is too wide, then that clip can move around the rim, or fall off. If the clip moves from the position where it is required then the out of balance problem can be exacerbated when compared to having no balance weight present.

### SUMMARY OF THE INVENTION

According to a first aspect of the invention there is provided a wheel balance clip comprising a spring portion arranged to accommodate and attach to the rim of a wheel; and an attachment portion depending from the spring portion, the attachment portion having a face wherein the face is provided with at least one protrusion, arranged such that, when in use, the at least one protrusion interacts with the rim of a wheel on which it is fitted so as to aid the retention of the clip such that the protrusion causes the face of the clip to move away from the rim.

Such an arrangement may be advantageous, as the provision of a protrusion may increase the stress in the spring portion when compared to a clip without a protrusion. The protrusion may also act to increase the pressure exerted by the attachment portion upon the rim, compared to a clip without a protrusion by providing a contact region of lesser area. In effect, the protrusion acts to aid retention of the clip.

It may be advantageous for the protrusion to interact with the vertical face of the rim of a wheel when in use.

Thus, the protrusion may be though of as being provided so as to increase the stress in the spring portion rather than to ‘hook’ onto the rim by means of a complimentary feature. This arrangement may be engineered by providing the protrusion so as it interacts with the outside face of the wheel rim.

The protrusion may be arranged to engage the flat surface of a wheel rim; i.e. the protrusion may be arranged not to require a groove or the like with which to interact. Such an arrangement is convenient as it allows the clip to be more universally used and/or does not require a rim to be modified before a clip can be mounted thereon.

Generally, the protrusion is on a region of the clip adjacent the attachment portion.

In some embodiments, the clip is arranged such that, on a side of the wheel on which the clip is attached, in use, the clip is arranged to contact the wheel at substantially only the protrusion and at a region of the spring portion.

The protrusion may be formed from a deformed region of the face. Such an arrangement may be advantageous, as this may allow for easy manufacture. Alternatively the protrusion may be formed from an appendage, attached to the face. Such an arrangement may be advantageous in larger clips, where the force applied through the protrusion from the spring when in use may be too great and act to deform the face back to an original state.

The wheel balance clip may be provided with a plurality of protrusions. Such an arrangement may be advantageous as this may provide for localised areas of increased pressure and/or ensure that the clip is evenly stressed across its width.

The protrusion on the clip may be provided with an upper region. The upper region may be substantially cambered. Such an arrangement may be advantageous, as this may allow easier fitting of the clip to the rim of a wheel.

The clip may comprise a second face, generally opposing the face from which the protrusion extends, which may be arranged to mount a balance weight thereupon. The second face may have a substantially planar surface for ease of attaching the two. Such mounting may be by way of adhesive, such as by adhesive tape. Such an arrangement may be advantageous, as it would allow balance weights of various masses to be mounted. If an adhesive substance, such as adhesive tape were to be used it may be advantageous if the adhesive substance were to be capable of withstanding the temperature of an oven used when powder coating, dip coating or the like. Such an arrangement may be advantageous, as this would allow the wheel balance assembly to be powder-coated, or dip-coated after assembly.

Alternatively the attachment portion may be arranged to have a balance weight cast thereupon, whereby the protrusion extends beyond the surface of cast balance weight so as to still interact with a rim to which the clip is attached. In yet further alternative or additional embodiments, the weight may be mounted on the clip with a means other than adhesive or casting such as riveting, soldering, welding or the like.

The clip may be provided with protection against corrosion, and/or damage. The clip may be painted, electroplated, galvanised, zinc plated and/or dip or powder coated. The colour of the clip may be altered for example so that it conforms to the colour of the wheel to which the clip is to be attached.

The spring portion may be arranged to accommodate a steel wheel rim. A steel rim may generally be in the region of 1 to 3 mm in thickness and in particular may be 1.5 to 2.5 mm in thickness. In contrast, a so-called alloy rim might typically be between 4 mm and 5 mm in thickness.

According to a second aspect of the invention there is provided a method of maintaining a wheel balance clip upon a rim of a wheel, comprising the steps of providing a clip comprising a spring portion, and an attachment portion depending therefrom, the attachment portion having a face with at least one protrusion therefrom, the method comprising attaching the clip to a rim such that the protrusion interacts with the rim upon which the clip is fitted such that the interaction of the protrusion with the rim tends to force the attachment portion away from the rim.

According to a third aspect of the invention there is provided a spring portion arranged to accommodate and attach to the rim of a wheel and an attachment portion depending from the spring portion, the attachment portion having a face wherein the face is provided with at least one protrusion, wherein the clip is arranged such that, when in use, the at least one protrusion interacts with the rim of a wheel on which it is fitted so as to aid the retention of the clip.

Any of the features discussed in relation to any of the aspects of the invention may be utilised in any of the other aspects of the invention.

### BRIEF DESCRIPTION OF THE DRAWINGS

There now follows, by way of example only, a detailed description of embodiments of the present invention with reference to the accompanying drawings of which:

FIG. 1 shows a background example to set the invention into context;

FIGS. 2a and 2b show a first embodiment of the present invention;

FIGS. 3a and 3b show the first embodiment of the present invention with the weight portion attached by adhesive;

FIG. 4 shows a second embodiment of the present invention; and

FIG. 5 shows a side elevation of a further embodiment and a cross section of a wheel rim.

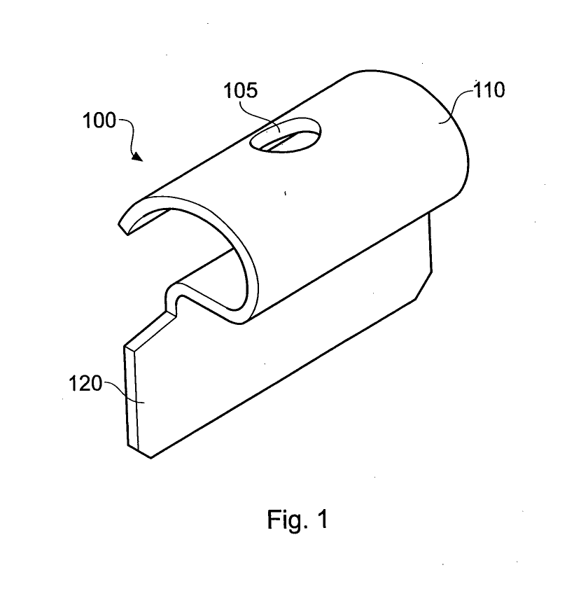

FIG. 1 shows a wheel balance clip 100 (hereinafter termed clip). The clip 100 comprises a U shaped spring portion 110 and an attachment portion 120, depending from the spring portion 110. The U-shape of the spring portion 110 is provided to accommodate and attach the clip 100 to a rim of a wheel. The attachment portion 120 is arranged such that a wheel balance weight may be cast thereupon or attached thereto, thus providing a consolidated wheel balance weight assembly. Furthermore the spring portion 110 is provided with a cut-out region 105, arranged to accommodate a removal tool.

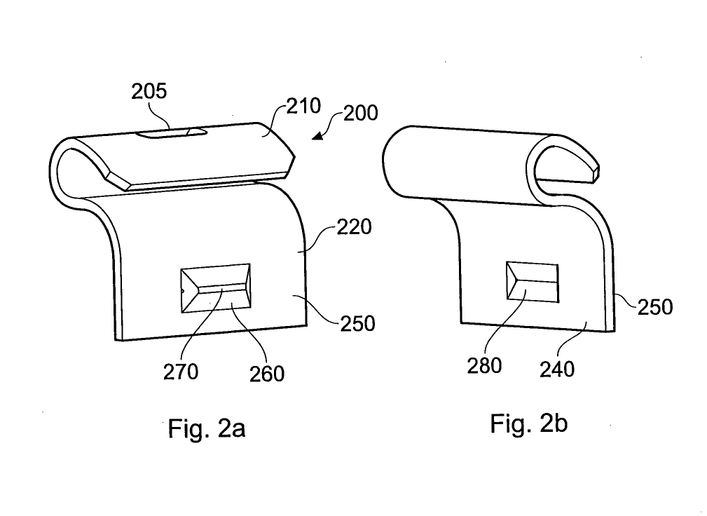

FIGS. 2a and 2b shows a first embodiment of the present invention wherein a clip 200 comprises a U-shaped spring portion 210 and an attachment portion 220, depending from the spring portion 210, wherein the spring portion 210 is provided with a cut-out region 205. The attachment portion 220 further comprises a face 250 and a second face 240, the second face 240 opposing the face 250.

In the present embodiment the second face 240 is arranged such that a wheel balance weight may be mounted thereupon, for example by adhesion, riveting, welding, etc. Where the wheel balance weight is adhesively mounted upon the second face, adhesive tape is used. The adhesive tape will generally be able to withstand the duration of exposure to temperatures used in a coating oven, such as those used in powder coating, dip coating or the like. In alternative embodiments the wheel balance weight may be arranged to be mounted upon the face 250 and the second face 250. In such an arrangement the wheel balance weight may be cast around the attachment portion 220. Should the balance weight be mounted using welding, then one or more projection welds may be used.

The face 250 is provided with a protrusion 260. The protrusion 260 is arranged to extend from the face 250. In this embodiment deforming a region of the attachment portion 220 forms the protrusion 260, such that the protrusion 260 on the face 250 has a complementary recess region 280 in the first face 240. In alternative embodiment the protrusion may be provided as an appendage. The appendage may be provided as a constituent component of the face 250, or as an additional component attached to the face 250. A person skilled in the art will readily understand how to implement such alternative arrangements.

In the present embodiment the protrusion 260 is formed as a generally oblong pyramidal shape. The protrusion 260 is also provided with a cambered upper surface region 270. In alternative embodiments the protrusion 260 may be provided with a tapered upper surface region 270, or an alternative configuration.

In the present embodiment the protrusion 260 is located in a central region of the face 250, although it will be readily appreciated that alternative configurations and locations of protrusion 260 may be used, and a person skilled in the art will be able to implement these. In addition, the protrusion 260 may extend for substantially the entire length and/or height of the face 250.

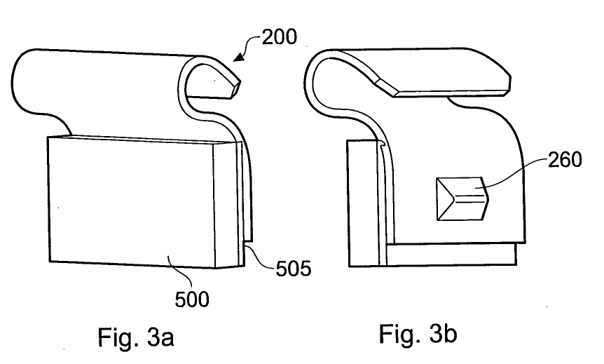

FIGS. 3a and 3b show one example of how the wheel balance clip 200 of the first embodiment may be used. In this figure the clip 200 is provided with an adhesive weight 500, mounted, via an adhesive connection 505 to the second face 240 of the attachment portion 220.

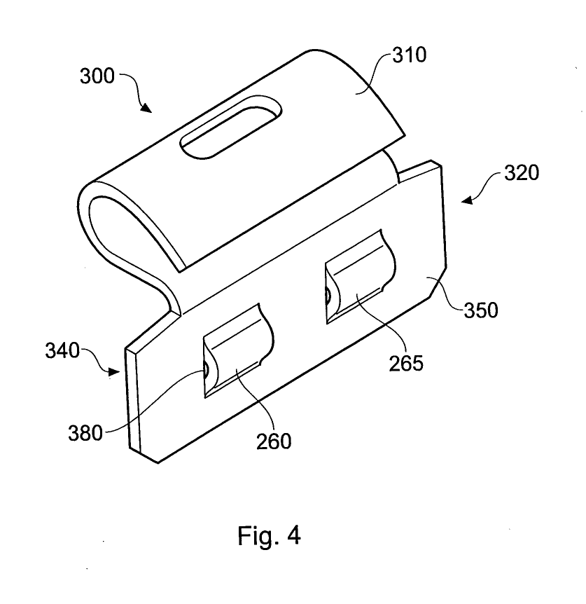

FIG. 4 shows an alternative embodiment wherein a clip 300 is again provided with a spring portion 310 and an attachment portion 320 is again provided with a face 350 and second face 340. In this embodiment, the face 350 is provided with two protrusions 260, 265. Again in this embodiment deforming a region of the attachment portion 320 forms each protrusion 260, 265, and provides complementary recess regions (not shown) on the second face 340. In the present embodiment, each protrusion 260 is substantially arcuate in shape, which again provide a cambered upper surface region 270. While in the present embodiment each protrusion 260 is positioned along a common longitudinal axis of the second face 350, in alternative embodiments the protrusions 260 may occupy any number of further regions of the second face 250. In alternative embodiments the clip 300 may be provided with any number of protrusions 260, such as 3, 4, 10, 20, etc. or any number in between these.

It will be readily appreciated that the protrusions 260 of different clips 200, 300 may differ in size and shape. For example, in the arrangement where a wheel balance weight is cast around the attachment portion 220, 320 the clip 200, 300 may be provided with a protrusion 260 that is able to extend beyond the surface of the wheel balance weight, once it has been cast in place. In addition it will be readily appreciated that the spring portion 210, 310 need not be a U-shaped spring portion 210, 310, and may be any other form of spring portion 210, 310, arranged to retain the clip 200, 300 on the rim 400 of a wheel and that contacts the rim in two locations as previously described.

The clip 200, 300 of the present invention may be provided with a protective, or sacrificial coating such as a dip or powder coating, galvanisation, zinc plating or electroplating or the like in order to prevent corrosion (or a combination of these coatings). In the present embodiment the clip is electroplated or zinc plated, which may be dip or powder coating, wherein the dip or powder coating may be coloured.

The clip 100 may be manufactured from a single material such as: plastic, steel, lead, zinc, etc. or each portion of the clip 100 may be manufactured from a different material. While the present embodiment the clip is manufactured from steel, in an alternative embodiment the spring portion 110 may be provided by one material, while the attachment portion 120 and or the protrusions 160 may be provided by another material.

It will readily be appreciated that any features of the second embodiment may be provided in the first embodiment and visa versa.

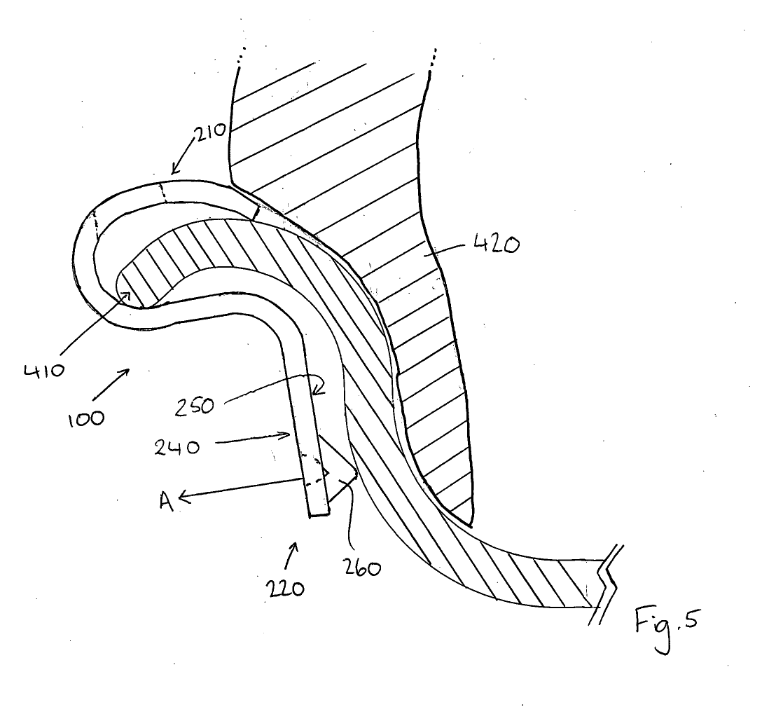

The embodiment shown in FIG. 5 has features in common with the first and second embodiment and like parts are referred to with the same reference numerals.

FIG. 5 shows that the U-shaped spring portion is placed over a rim 400 of a wheel. The protrusion 260 is arranged such that it interacts with the rim 400 of the wheel, and thus increases the stress in the spring portion 210. This interaction of the protrusion causes the face 250 of the clip to move away from the rim 400 in the direction of the arrow A in the Figure.

Advantageously the protrusion 260 creates a pivot point such that the distal end of the U-shaped spring portion is driven toward the top of the rim 400, facilitating retention of the clip when the protrusion is provided. It will be appreciated by those skilled in the art that this system is advantageous over clips without a protrusion, as the gripping force can be increased. The present arrangement is suitable for steel rims that have a lip (angled to have a downward pointing profile), but can also be used on wheel rims of different compositions and having differently angled profiles.

It can be seen that the wheel balance clip 100 is arranged such that, on a side of the wheel rim 400 on which the clip 100 is attached, in use, the clip 100 is arranged to contact the wheel rim 400 at substantially only the protrusion 260 and at a region of the spring portion 210. In the Figure, it can be seen that the end region of the wheel rim 400 contacts the spring portion 210 and that the face 250 does not substantially contact the wheel rim 400.

Also, this Figure shows how the distal end region 410 of the wheel rim 400 is rolled over, as would typically be the case with a wheel rim fabricated from steel, in order to help prevent a tyre wall 420 (shown schematically in place on the rim 400) from being damaged as the tyre is fitted to the rim 400, to ease fitment of a tyre and also to help strengthen the rim 400.

1-26. (canceled)

27. A wheel balance clip comprising:
a spring portion arranged to accommodate and attach to the rim of a wheel; and
an attachment portion, arranged to have a balance weight attached thereto, depending from the spring portion, the attachment portion having a face wherein the face is provided with at least one protrusion, arranged such that, when in use, the at least one protrusion interacts with the rim of a wheel on which it is fitted so as to aid the retention of the clip such that the protrusion causes the face of the clip to move away from the rim.

28. A wheel balance clip according to claim 27 wherein a principal dimension of the at least one protrusion is substantially parallel to a normal vector to a plane of symmetry of the spring portion.

29. A wheel balance clip according to claim 27, wherein the, or each protrusion has an upper region which is substantially cambered.

30. A wheel balance clip according to claim 27, wherein the protrusion is arranged, in use, to interact with the vertical face of the rim of a wheel.

31. A wheel balance clip according to claim 27 wherein the protrusion is provided so as to interact with the outside face of the wheel rim.

32. A wheel balance clip according to claim 27, wherein the protrusion is formed from a deformed region of the attachment portion.

33. A wheel balance clip according to claim 27, wherein the protrusion is formed from an appendage, attached to the face.

34. A wheel balance clip according to claim 27 wherein the, or each protrusion is arranged to extend substantially perpendicular from the face.

35. A wheel balance clip according to claim 27 wherein a second face, opposing the first, is arranged to have a balance weight mounted thereupon.

36. A wheel balance clip according to claim 27 where the second face has a substantially planar surface.

37. A wheel balance clip according to claim 27, wherein the attachment portion is arranged to have a balance weight riveted thereupon.

38. A wheel balance assembly comprising a balance weight and a clip according to claim 27.

39. A method of maintaining a wheel balance clip upon a rim of a wheel, comprising the steps of:
providing a clip comprising a spring portion, and an attachment portion depending therefrom, the attachment portion having a face with at least one protrusion
attaching the clip to a rim such that the protrusion interacts with the rim upon which the clip is fitted such that the interaction of the protrusion with the rim tends to force the attachment portion away from the rim.

40. A method according to claim 39 wherein the protrusion is provided so as to interact, in use, with the outside face of the wheel rim.

41. A method according to claim 39 wherein protrusion interacts, in use, with the vertical face of the rim of a wheel.

42. A method according to claim 39 wherein protrusion is provided by deforming a region of the attachment portion.

43. A method according to claims 46, wherein the protrusion is provided from an appendage, attached to the face.

44. A combination of a wheel balance clip according to any of claim 27 mounted on a wheel.

45. A wheel balance clip according to claim 27 where in principal dimension of the at least one protrusion is substantially parallel to a tangent of a radius of a wheel to which the clip is, in use, fitted.

46. A wheel balance clip according to claim 27, wherein the attachment portion is arranged to have a balance weight welded thereupon.
